(19) United States
(12) Patent Application Publication
(10) Pub. No.: US 2023/0371745 A1
(43) Pub. Date: Nov. 23, 2023

(54) VORTEX TABLE BARBECUE AND METHOD FOR USING A BARBECUE

(71) Applicant: BMSM APS, Solbjerg (DK)

(72) Inventor: Jakob MATTHIESEN, Solbjerg (DK)

(21) Appl. No.: 18/024,299

(22) PCT Filed: Sep. 3, 2021
(86) PCT No.: PCT/DK2021/050269

§ 371 Date: Mar. 2, 2023

(30) Foreign Application Priority Data
Sep. 4, 2020 (DK) PA 2020 70573

(51) Int. Cl. A47J 37/07

(52) U.S. Cl. CPC A47J 37/0754; A47J 37/0704

(57) ABSTRACT

A barbecue and a method for using a barbeque is provided, the barbecue including housing, the housing surrounding an upwards open cavity, where two side limitations constituting sides and the remaining two sides constituting end walls, the side limitations on either side of the upwards open cavity with a first cavity and a second bottom spaced from the first bottom having a second cavity, where first and second cavities are in fluid communication, and further that an exhaust is provided in fluid communication with said first and second cavities for creating a draft in said exhaust whereby gas will flow from the first and second cavities out through the exhaust, and where one or more vortexes are created above the charcoal, said vortexes rotating around a horizontal axis where the axis extends between apertures arranged in opposing side walls.

### CROSS-REFERENCE TO RELATED APPLICATIONS

This application claims priority to PCT Application No. PCT/DK2021/050269, having a filing date of Sep. 3, 2021, which is based DK Application No. PA 2020 70573, having a filing date of Sep. 4, 2020, the entire contents both of which are hereby incorporated by reference.

### FIELD OF TECHNOLOGY

The following is directed to a novel barbecue having a particular construction which by the physical construction of the parts of the barbecue substantially eliminates smoke rising from barbecuing various items on the barbecue from escaping from the barbecue. Furthermore, the following is also directed to a method of using such a barbecue.

### BACKGROUND

It is well-known to barbecue for example meat, vegetables and the like. For this purpose, a host of different barbecue designs exist which usually have a number of features in common. Firstly, they all have a bottom or grill on which the charcoal is to be positioned. Alternatively, barbecues using gas as the heating medium may be used where a gas burner is positioned instead of the charcoal. Above the source of heat—whether it be charcoal or gas—a grill is positioned such that any items, which it is desirable to barbecue may be arranged on the top surface of the grill such that the heat generated by the charcoal, or the gas burner will heat and cook the items placed on the grill. At the same time the grill (usually steel rods) may be heated such that the rods, bars or slaps of the grill will leave a mark on the items to be cooked on top of the grill. During the cooking process juices or debris from the items being grilled will fall down onto the heating source where it will be burnt, which during that process develops smoke. Also, the intense heat from the gas burner or the charcoals will cause the items arranged on the grill to burn or at least create evaporation of fats and oils, such that further smoke is generated.

Depending on the actual position of the barbecue the cooking process and the smoke generated by this process may be very annoying to the people attending to the barbecue whether it be sitting around the table in which the barbecue is built into or attending a freestanding barbecue.

JPH 07-051168 disclose a traditional annular-shaped hotplate for indoor use. In order to avoid expensive and often impossible construction of an exhaust construction, in order to evacuate smoke and odours arising from the cooking process on the hotplate, the sides of the hotplate are provided with openings, and a central ventilation tower is provided. Furthermore, a fan is provided such that the smoke/odour from the cooking process may be sucked into some of the openings, led through an oil filter and a deodorizing filter (active coal) and then re-circulated out across the hotplate towards the intake openings. In this manner the forced circulation of gas/smoke is created, where the smoke flow is radial, meaning that the smoke either flows towards or away from a centre in the annular shaped hotplate depending on how the ventilation/fan is effecting the air/smoke flow.

It is generally accepted that the overwhelming part of smoke developed is created when fat and juices from the objects being barbequed drips onto the charcoals or other heating means. Consequently, in embodiments where the hotplate is rectangular and where the objects to be heated/cooked are arranged directly onto the hotplate, the smoke will be developed from the plate. The lateral movement of smoke across the hotplate from apertures in one side into the apertures in the other side will be hampered by the objects to be cooked on the hotplate—thereby requiring a substantial creation of airflow, in order to avoid smoke from escaping the cooking zone.

Similar constructions are known from KR101998519, KR101680521 and JP 2004-290379.

### SUMMARY

An aspect relates to a solution in that it is achieved by the inventive special construction of the barbecue according to embodiments of the present invention to a large degree to completely avoid that any smoke generated during the cooking process will escape from the space below the grill to the ambient surroundings. Particularly in barbeque constructions the burning of charcoal and the thereby generated smoke, together with the smoke generated from burning fat and debris from items being cooked, generate large amounts of smoke, which is undesirable.

Embodiments of the invention address this by providing a barbecue, where two side limitations constituting sides and the remaining two sides constituting end walls, the side limitations on either side of the upwards open cavity has an outer wall and an inner wall with a first cavity between the outer wall and the inner wall, and where apertures facing the open cavity are provided in the inner walls, and where a first bottom is provided in the open cavity, the first bottom along its periphery connected to the inner side walls and end walls, and a second bottom spaced from the first bottom thereby defining a second cavity, where the second bottom along its periphery is connected to the outer side walls and the end walls, where the first and second cavities are in fluid communication, and further that an exhaust is provided in fluid communication with the first and second cavities, and where means are provided for creating a draft in the exhaust whereby gas will flow from the first and second cavities out through the exhaust.

Particularly, the feature of providing a cavity between the cooking space i.e., between the open space suitable to arrange the charcoal in, and the exterior of the barbecue in combination with apertures connected to the open space and providing the apertures in the side walls limiting the open space facilitates a desirable air/gas flow. The gas, typically smoke may/will be evacuated through the apertures, which are below the upper rim of the open cavity, and as such the gas/smoke will not escape up from the heating space.

The side walls will typically be parallel as will the end walls, such that the sidewalls and the end walls form a rectangle surrounding the open cavity. The gas/smoke flow will thereby be linear towards the apertures in the sidewalls. This linear flow will be influenced by the thermically induced upwards airflow generated by the charcoals, and vortexes will form. These vortexes will tend to “suck” in the smoke and as such further avoid that smoke may escape the cooking space.

The side walls and the end walls may however have other shapes (curved, semi-circular etc). The vortexes will form between two facing apertures.

The cavities both in the side walls and the bottom are connected to an exhaust. Furthermore, means are provided in the exhaust such that an under pressure will be created inside the cavities whereby a suction effect through the apertures between the open cavity and the cavities will be created. In this manner the smoke will be sucked out of the open cavity into the first cavity.

Furthermore, with this construction the exhaust pattern will create a flow through the apertures such that one or more vortexes are created inside the open cavity. The vortexes will have an axis substantially spanning from an aperture in one sidewall to the aperture in the opposite side wall, such that the vortex will rotate around the axis.

In this context the term vortex shall be interpreted as a mass of air, gas or smoke, which spins around the axis and in the process pulls or sucks additional air, gas or smoke from the immediate vicinity of the vortex, into the vortex. At the same time the under pressure in the first and second cavities will evacuate the smoke, gas or air in the vortex and lead it to the exhaust for evacuation to the ambient environment.

It is clear that the conventional art devices discussed above having radial airflow will not be able to create vortexes, as they all have a radial airflow in the cooking space. The radial airflow will interfere with any vortex generation, and thereby the improved retaining of smoke inside the cooking space cannot be provided. This in turn provides the possibility for less fan action with the present invention as the escape of smoke is limited due to the generation of vortexes. In the conventional art where radial smoke flow is achieved, the avoidance of smoke escape shall be achieved solely by the provision of a powerful fan.

In a further embodiment of the invention, the means for creating the draft in the exhaust comprises a chimney upstanding from the first bottom, the chimney being in gas communication with the first and/or second cavities, and a heating source surrounding the bottom of the chimney.

By providing a heating source surrounding the bottom of the chimney, i.e. both the bottom plate and part of the chimney shaft, which in this connection shall be understood as the interface between the chimney and the first bottom, the heating means will heat the air inside the chimney whereby an upward draft is created thereby creating suction in the cavities and as such an airflow through the apertures from the open cavity into the cavities. This effect (chimney effect) is sufficient in order to evacuate the gas and smoke created during the cooking and furthermore due the arrangement of the apertures whereby the vortexes are created, substantially no smoke or gas will escape the open cavity of the barbecue.

In a further embodiment, the heating source is charcoals optionally arranged in a tray surrounding the base of the chimney, or an electrical heater element, or gas burner.

As charcoals may be used as a heating/cooking source the hot charcoals are already present and as such the charcoals are already available such that a simplified version of embodiments of the invention are available in that no secondary heating source or other means in order to create the exhaust through the chimney is necessary. The charcoals will heat the chimney pipe and as such create hot air inside the chimney, which hot air will rise through the chimney thereby creating an under-pressure such that the under-pressure is conveyed/connected to the cavities and thereby causes an intake of smoke through the apertures. This intake in turn causes the one or more vortexes, as described above.

Alternatively, a gas heater or an electrical heater may be used in order to create the gas movement/draft whereby the smoke is evacuated from the open cavity. The gas burner or electrical heater may also be used instead of or as a supplement to the charcoals.

In an embodiment, a fan is provided in the exhaust in order to create draft in the cavities.

When using a fan in order to create the draft, the evacuated gas may be guided/led out through the evacuation means as for example a ventilation system connected to the barbecue. For indoor use this feature provides the possibility of building the barbecue into tables and lead the evacuated gas out through the bottom (second bottom) of the barbecue in conduits connected to a suitable smoke evacuation system.

In further embodiment of the invention, the means for creating the draft in the exhaust comprises a chimney upstanding from the first bottom, the chimney being in gas communication with the first and/or second cavities, and wherein a fan is provided inside the chimney creating an upwards airflow through the chimney.

By providing a fan creating the airflow through the chimney it is assured that a very reliable source of flow and thereby creation of under-pressure is made available. Naturally the fan may be regulated such that optimum airflow is created i.e., an airflow, where the under-pressure in the cavities has such a magnitude that the gas flow through the apertures creates and maintains the vortexes whereby substantially no smoke particles may escape the open cavity.

In a further embodiment, a second wall element is arranged spaced from one or both inner side walls and parallel with the side walls and extending substantially perpendicularly from the first bottom.

The secondary wall element serves to isolate the side walls from the hard charcoals, such that the temperature difference between the smoke/air in the cavities may be enlarged. This is important in that if the air/gas/smoke in the cavities is heated it will tend to rise thereby counteract the under-pressure created by the chimney and as such the suction effect may be diminished. The secondary wall element creates the isolation such that the heat from for example the charcoals is not immediately transmitted to the cavities whereby the under-pressure and thereby the suction is maintained.

In a further embodiment, the first bottom is suitable to accommodate hot charcoals, and means are provided on or along an upper part of the inner sidewalls for supporting a griddle, grill or other means for supporting food items to be cooked over the charcoals. In some embodiments it may be desired to provide special bottom characteristics in order to accommodate the charcoals for example as such that the charcoals may be assembled in specific areas of the first bottom or that it is possible to maintain a pile of charcoals by not having a completely flush first bottom plate. In other embodiments the first bottom may be provided with small elevations such that it is possible to circulate air around the charcoals whereby the burning of the charcoals becomes more even. The griddle, grill or other means for supporting food items to be cooked over the charcoals, is typically arranged above the apertures in the side walls.

In a still further embodiment of the invention, the barbecue is provided with a grill, which grill comprises a plurality of spaced and substantially parallel steel slabs arranged with a mutual distance, where in use when the grill is arranged above the first bottom, at least one slab is positioned partly overlapping an upper edge of an end wall.

The fact that the grill is made from a plurality of steel slaps provides the possibility of arranging the grill such that one of the slaps is superposed an end wall whereby smoke rising from the first bottom towards the grill along the end wall will be forced to flow inwards relative to the end wall thereby stimulating the ability of the vortex to suck in particles from the smoke with the result that less smoke/gas is able to escape the open cavity.

The other slabs of the grill may be arranged orthogonal to the end wall (and thereby also orthogonal to the slab superposed the end wall), such that these do not create turbulence in the smoke's movement or vortex in the open cavity. The slabs may also be arranged diagonally with respect to the side walls. In practice this design has proven to aid the smoke towards the apertures in the sidewalls. The diagonally arranged slabs guides the smoke in the vortex, towards the apertures.

In the alternative to having a slab of the grill overlapping an end wall, a dedicated slab or plate may be arranged adjacent the end wall, extending into the cavity. The plate will typically be arranged close to the top of the end wall (furthest away from the bottom). As is the case with the slab of the grill this plate will enforce the creation and maintenance of the vortex, and thereby further strengthen the constructions' ability to suck the smoke out into the cavities, before it reaches the ambient environment immediately adjacent the barbeque. Furthermore, a small gap or inlet may be provided between or in the plate and the end wall. This inlet (gap or aperture) will serve as an equalizer, such that pressure differences inside and outside the inner cavity does not influence or hamper the vortex or the formation of the vortex.

It is also contemplated that the plates will strengthen the vortex further if they are moved slightly towards the bottom plate relative to the edge of the end wall. Further strengthening of the vortex may be achieved by the plates being curved.

Furthermore, the first bottom may also be shaped as pyramid, such that the chimney or exhaust is arranged in the apex of the pyramid and the lower corners are in the corners of the first bottoms connection with sidewalls/end walls. In this manner the exhaust air/smoke will be guided towards the exhaust/chimney, and as hot air/smoke tends to move upwards, the upward sloping first bottom (when seen form the cavity between the first and second towards the exhaust/chimney) will encourage the smoke towards the exhaust.

Embodiments of the invention are also directed to a method of using a barbecue as described above, where the barbecue comprises a four-sided housing the housing surrounding an upwards open cavity, where two side limitations constituting sides are parallel and the remaining two sides constituting end walls are parallel, the side limitations on either side of the upwards open cavity has an outer wall and an inner wall with a first cavity between the outer wall and the inner wall, and where apertures facing the open cavity are provided in the inner walls, and where a first bottom is provided in the open cavity, the first bottom along its periphery connected to the inner side walls and end walls, and a second bottom spaced from the first bottom thereby defining a second cavity, where the second bottom along its periphery is connected to the outer side walls and the end walls, where the first and second cavities are in fluid communication, and further that an exhaust is provided in fluid communication with the first and second cavities, and where means are provided for creating a draft in the exhaust whereby gas will flow from the first and second cavities out through the exhaust, and where one or more vortexes are created above the charcoal, the vortexes rotating around a horizontal axis where the axis extends between apertures arranged in opposing side walls.

### BRIEF DESCRIPTION

Some of the embodiments will be described in detail, with references to the following Figures, wherein like designations denote like members, wherein:

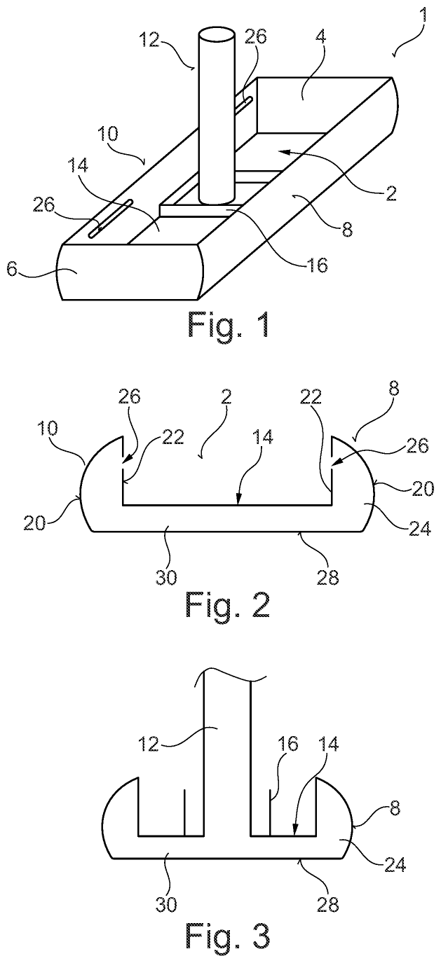

FIG. 1 illustrates a schematic illustration of an embodiment of a barbecue according to embodiments of the present invention;

FIG. 2 illustrates a cross section through the barbecue 1 illustrated in FIG. 1;

FIG. 3 illustrates a cross-section through the barbecue 1 at a position with the tray and chimney;

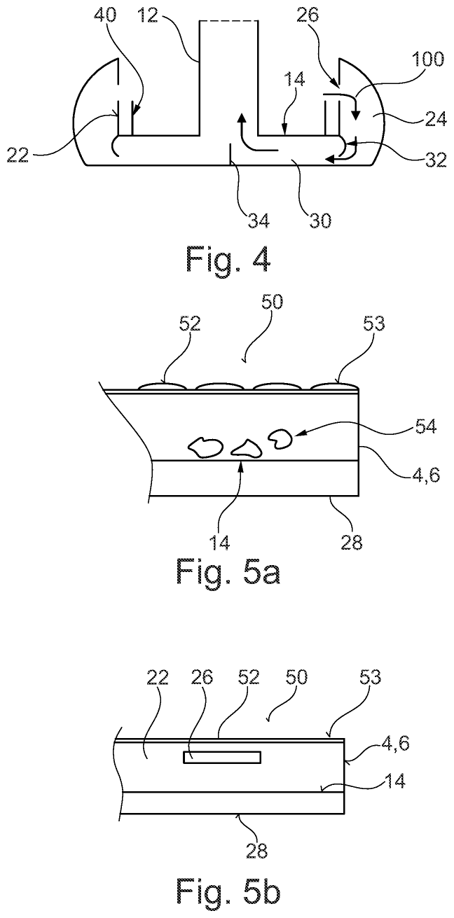

FIG. 4 illustrates the airflow through the cavities and up through the chimney;

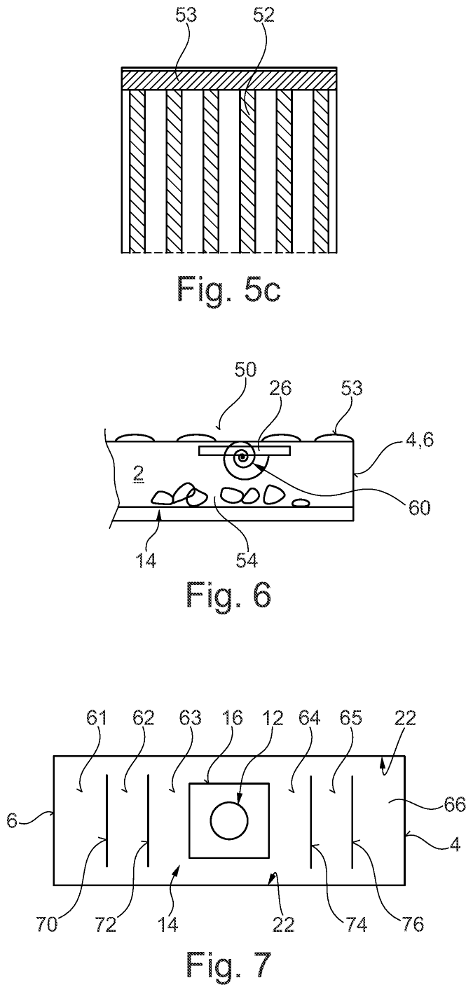

FIG. 5a illustrates a cross section where a grill has been arranged on top of the open cavity;

FIG. 5b illustrates a cross section vertically through and end section of the barbecue;

FIG. 5c being a plane view from above of a section of the barbecue;

FIG. 6 illustrates a cross-section through the barbecue in use; and

FIG. 7 illustrates a plane overview of the barbecue where the open cavity has been divided into sections.

### DETAILED DESCRIPTION

The barbecue 1 comprises an open cavity 2 which is limited by end walls 4, 6 and side limitations 8, 10. Furthermore, in this embodiment a chimney 12 is provided upstanding from a first bottom 14 provided in the open cavity 2. The chimney 12 is connected to the first bottom 14 such that the chimney's opening will penetrate the first bottom 14. Furthermore, the chimney is surrounded by a tray 16.

Turning briefly to FIG. 2 illustrating a cross section through the barbecue 1 illustrated in FIG. 1 it may be seen that the side limitations 8, 10 are hollow and delimited by an outer side wall 20 and an inner side wall 22. The inner and outer side walls 20, 22 delimit a first cavity 24. In the inner side 22 apertures 26 are provided such that there is gas communication between the open cavity 2 through the apertures 26 into the first cavity 24.

Furthermore, a second bottom 28 is provided spaced from the first bottom 14 such that a second cavity 30 is provided between the first bottom 14 and second bottom 28 and the side limitation 8, 10. The first cavity 24 is in gas communication with the second cavity 30.

Turning back to FIG. 1 the chimney 12, which—as already mentioned above—penetrates the first bottom 14 is in gas communication with the second cavity 30 such that in use smoke and other gases are evacuated through the apertures 26 into the first and second cavities 24, 30 and thereafter evacuated through the chimney 12.

In use a heat medium for example charcoals will be arranged in the tray 16 surrounding the chimney 12 such that the air inside the chimney 12 will be heated and caused to rise through the chimney creating the under-pressure described above.

The inner side walls 22 and/or the end walls 4 may be given a concave-cross-section (not illustrated), such that the curvature of these walls/side walls will encourage smoke to move towards the centre. Particularly by providing a curved shape to the end walls 4 the smoke will be guided towards vortexes created in the open cavity.

Furthermore, the open cavity limited by the sides 22 and the end walls may be separated in a number of sections, by positioning section walls spanning between the inner sides 22. This provides at least two advantages. Firstly, the sections will when apertures are arranged in the side walls in each section create a plurality of vortexes—one to two in each section. Each vortex thereby becomes more effective as the smoke will not have to travel far inside the open cavity before being evacuated, as the vortexes in each cavity will evacuate smoke there. Furthermore, it is also possible to only use a smaller section of the open cavity for barbequing thereby saving charcoal. Sections closer to the exhaust should be used first in order to stimulate the airflow through the exhaust.

In FIG. 3, a cross-section through the barbecue 1 is illustrated at a position with the tray and chimney. As may be seen, the tray 16 surrounds the chimney 12 and has an upper extension such that sufficient charcoal or other heating media may be arranged inside the tray 16 surrounding the chimney 12 in order to create the upwards draft in the chimney 12 causing the under-pressure in the cavities 24, 30.

In the use situation charcoal will be arranged on the first bottom 14 as well as in the tray 16 such that an upward draft is created inside the chimney 12 creating an exhaust for smoke and other gases generated during the barbecue process. The apertures 26 provided in the inner side walls will, due to the upwards draft in the chimney create suction from the open cavity such that smoke and gases generated by the barbecue in the cooking process will be sucked out through the apertures, travel with the airflow through the first and second cavities 24, 30 and finally be expelled through the chimney 12 due to the draft of the exhaust.

In order to create the suction, a fan may be provided as an alternative or in addition to the tray 16 with the hot coals. In such embodiments the chimney/exhaust 12 may be arranged differently for example connected to domestic ventilation systems or the like.

The airflow through the cavities and up through the chimney may be further improved by providing airflow guide members illustrated with reference to FIG. 4. In FIG. 4 the airflow is illustrated by the arrows 100. It is well-known from fluid dynamics that sharp edges, corners etc. creates turbulence and therefore disturbs the flow and for this reason airflow guide members 32, 34 are provided in the cavities 24, 30 in order to smooth out the flow 100 of the circulating air. Around the intake for the exhaust, i.e., in the space between the first and second bottom adjacent the exhaust, the air flow guide members may be arranged as vanes and curved, such that the smoke is guided into the exhaust given a rotation. Particularly in embodiments where the exhaust comprises a chimney, the rotation combined with the upward draft will assure a steady and strong smoke movement up through the chimney assuring a powerful expiration of smoke from the open cavity. As illustrated in the cross-sectional views depicted in FIGS. 2, 3 and 4 the outer side wall is provided with a curvature. This is done in order to facilitate and smooth the airflow but naturally the outer side may have any configuration. From a production point of view, it may be desired to provide straight plate members which are welded together (creating rectangular or square cross-sections) but for optimum airflow the curved part, as illustrated in the cross sections, is desired.

A further feature is illustrated in FIG. 4, namely the fact that there are provided second wall elements 40 parallel to and at a distance from the inner side walls 22. These secondary wall elements 40 serve to isolate the inner side wall from the heat generated by the coal arranged on the first bottom 14. In this manner it may be achieved that the air circulation indicated by the arrow 100 is not slowed down due to the heating of the inner walls, which will cause the air to rise—and thereby try to move against the flow created by the under-pressure in the chimney.

It is a well-known fact that heated air will tend to rise and as such if the inner wall 22 is heated this heat will also influence the airflow 100 inside the cavity 24 and thereby diminish the suction effort in the cavities created by the upper draft and the exhaust/chimney 12. By providing the secondary wall element the inner side walls are at least to a certain degree isolated from the heat generation by the charcoals positioned on the first bottom 14.

In FIG. 5a illustrated a cross section where a grill 50 has been arranged on top of the open cavity i.e., more like the use situation. The grill 50 comprises a number of slats/slaps 52. As may be seen in FIG. 5a the outermost slaps 53 are arranged parallel to the end walls 4,6 and overlays the end walls such that smoke rising from the hot charcoals 54 along the end wall 4,6 will encounter the slap 53. In this manner the smoke/gas will be forced to follow the underside of the slap 53. This will—as should be apparent from the illustration in FIG. 6 cause any smoke particles and gas to be absorbed in the vortex 60 and thereby evacuated to the apertures 26. By overlaying the slaps over the end walls, less smoke will be able to escape the open cavity, before the smoke is guided towards the exhaust.

In FIGS. 5b and 5c (FIG. 5b being a cross section vertically through an end section of the barbecue, FIG. 5c being a plane view from above) is illustrated an embodiment where the grill 50 comprises an end slab 53 (hatched lines) overlapping the end wall (4,6) and the grill slabs 52 arranged orthogonal to the end slab 53. In this manner the slabs 52 will interfere as little as possible with the smoke movement and in particular the vortex, whereby the evacuation of smoke is stabilised.

Turning to FIG. 6, a cross-section through the barbecue in use is illustrated. On the first bottom 14 a number of charcoals 54 is arranged, such that heat, smoke and other gases will become present/be created inside the open cavity 2. The open cavity is delimited by a grill 50 as described above, see FIGS. 5a-c. In the inner side walls 22 apertures 26 are provided, which as already described before are connected to the cavities such that as an upward gas flow is created in the chimney (not illustrated in FIG. 6 but see FIG. 1, 3 or 4) the apertures will evacuate any smoke or gas created in the open cavity 2. Due to the special configuration of the apertures and the grill, vortexes 60 will be created, where a longitudinal axis of the vortexes will be between the opposing inner side walls. The axis will be positioned superposed the apertures 26 such that although the vortexes 60 will rotate as illustrated in FIG. 6 the under-pressure inside the cavities will create suction through the apertures 26 thereby evacuating smoke and other gases from the open cavity 2. At the same time due to the suction action of the vortexes 60 also gas/smoke in the vicinity of the vortex 60 will be sucked into the vortex and thereby effectively evacuated through the apertures 26. The vortexes are further enforced by the provision of the outermost slap 53 of the grill being superposed the end walls 4, 6 such that the airflow along the end wall 4, 6 will be bent and forced to flow in the direction towards the vortex.

In FIG. 7 is illustrated a plane overview of a barbecue (grill removed) according to an embodiment of the invention. The open cavity, delimited by side walls 22 and end walls 4,6 and first bottom 14, is sub-divided into sections 61, 62, 63, 64, 65, 66 by section walls 70,72,74,76. The section walls are arranged substantially inside the open cavity between opposite side walls. In each section is provided apertures in the side walls, such that vortexes will be created in each section, during use as described above. This will improve the evacuation of smoke from each cavity and from the barbecue overall.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A barbeque comprising a four-sided housing, the housing surrounding an upwards open cavity, where two side limitations constituting sides, and the remaining two sides constituting end walls, the side limitations on either side of the upwards open cavity has an outer wall and an inner wall with a first cavity between the outer wall and the inner wall, and where apertures facing the open cavity are provided in the inner walls, and where a first bottom is provided in the open cavity, the first bottom along its periphery connected to the inner side walls and end walls, and a second bottom spaced from the first bottom thereby defining a second cavity, where the second bottom along its periphery is connected to the outer side walls and the end walls, where the first and second cavities are in fluid communication, and further that an exhaust is provided in fluid communication with the first and second cavities, and where means are provided for creating a draft in the exhaust whereby gas will flow from the first and second cavities out through the exhaust and where means are provided on or along an upper part of the inner sidewalls above the apertures for supporting a griddle, grill or other means for supporting food items to be cooked over the charcoals.

2. The barbeque according to claim 1, wherein the means for creating the draft in the exhaust comprises a chimney upstanding from the first bottom, the chimney being in gas communication with the first and/or second cavities, and a heating source surrounding the bottom of the chimney.

3. The barbeque according to claim 2, wherein the heating source is charcoals optionally arranged in a tray surrounding the base of the chimney, or an electrical heater element or a gas burner.

4. (canceled)

5. The barbeque according to claim 1, wherein the means for creating the draft in the exhaust comprises a chimney upstanding from the first bottom, the chimney being in gas communication with the first and/or second cavities, and wherein a fan is provided inside the chimney creating an upwards airflow through the chimney.

6. The barbeque according to claim 1, wherein the exhaust comprises a fan creating an airflow from the first cavity and/or the second cavity to the ambient surroundings of the barbecue.

7. The barbeque according to claim 1, wherein a secondary wall element is arranged spaced from one or both inner side walls and parallel with the side walls, and extending substantially perpendicularly from the first bottom.

8. The barbeque according to claim 1, wherein one or more air flow guide members are provided in the first cavity and/or the second cavity and/or the open cavity guiding the air flow from the apertures in the inner sidewalls through the first and second cavities to the exhaust.

9. The barbeque according to claim 1, wherein the first bottom is suitable to accommodate hot charcoals.

10. The barbeque according to claim 1, wherein a grill comprising a plurality of spaced and substantially parallel steel slabs arranged with a mutual distance is provided, where in use when the grill is arranged above the first bottom, at least one slab is positioned partly overlapping an upper edge of an end wall.

11. A for using a barbecue, the barbecue comprising a four-sided housing, the housing surrounding an upwards open cavity, where two side limitations constituting sides are parallel and the remaining two sides constituting end walls are parallel, the side limitations on either side of the upwards open cavity has an outer wall and an inner wall with a first cavity between the outer wall and the inner wall, and where apertures facing the open cavity are provided in the inner walls, and where a first bottom is provided in the open cavity, the first bottom along its periphery connected to the inner side walls and end walls, and a second bottom spaced from the first bottom thereby defining a second cavity, where the second bottom along its periphery is connected to the outer side walls and the end walls, where the first and second cavities are in fluid communication, and further that an exhaust is provided in fluid communication with the first and second cavities, and where means are provided on or along an upper part of the inner sidewalls for supporting a griddle, grill or other means for supporting food items to be cooked over the charcoals and where means are provided for creating a draft in the exhaust whereby gas will flow from the first and second cavities out through the exhaust, and where one or more vortexes are created above the charcoal and below the supporting griddle, grill or other means for supporting the food items to be cooked, the vortexes rotating around a horizontal axis where the axis extends between apertures arranged in opposing side walls.
